(19) United States
(12) Patent Application Publication
(10) Pub. No.: US 2025/0121490 A1
(43) Pub. Date: Apr. 17, 2025

(54) EXOSKELETON APPARATUS TO ASSIST MOVEMENT OF USER USING BRAIN SIGNALS

(71) Applicants: Abdul Salam Abu Baker, Ajman (AE); Mirza Faizan, Irving, TX (US); Yusuf Abu Baker, Ajman (AE); Noah Abu Baker, Ajman (AE)

(72) Inventors: Abdul Salam Abu Baker, Ajman (AE); Mirza Faizan, Irving, TX (US); Yusuf Abu Baker, Ajman (AE); Noah Abu Baker, Ajman (AE)

(21) Appl. No.: 18/378,954

(22) Filed: Oct. 11, 2023

(51) Int. Cl. B25J 9/00; G06F 3/01; G06T 11/00

(52) U.S. Cl. CPC B25J 9/0006; G06F 3/015; G06T 11/00

(57) ABSTRACT

An exoskeleton apparatus and a method to assist movement of user using brain signals is provided. The exoskeleton apparatus renders a set of images on a display device and further receives one or more brain signals associated with a brain of a user. The exoskeleton apparatus further determines a first frequency associated with the received one or more brain signals and compares the determined first frequency with a frequency corresponding to each image of the set of images. Further, the exoskeleton apparatus determines a first action to be performed by the user within a first pre-specified time period based on the comparison. The exoskeleton apparatus generates a first set of control signals associated with the determined first action. The exoskeleton apparatus controls one or more actuators embedded within the exoskeleton apparatus based on the generated first set of control signals.

### TECHNOLOGICAL FIELD

The present disclosure generally relates to an exoskeleton apparatus, and more particularly to an exoskeleton apparatus to assist the movement of a user using brain signals.

### BACKGROUND

With advancements in the field of robotics, exoskeleton apparatuses have been developed that assist user movements or actions (such as walking, sitting, and the like). Generally, an exoskeleton apparatus is a mechanical or a robotic device that is worn externally on the human body and resembles to a frame or a suit. The primary purpose of the exoskeleton apparatus is to augment, enhance, and/or assist the wearer's physical abilities, often in terms of strength, endurance, and/or mobility. Specifically, the exoskeleton apparatus is designed to be strapped or attached to the user's limbs, torso, or entire body and is equipped with sensors, motors, and control systems to provide support or assistance to the user. Also, the exoskeleton apparatus further enables the users with mobility disorders to walk and engage in activities that would otherwise be challenging to accomplish. Furthermore, the exoskeleton apparatuses are also used in a variety of fields such as healthcare, military, industry, and research, where they may aid users with mobility impairments, reduce physical strain on workers, or enhance the capabilities of soldiers and workers in demanding environments.

Traditional exoskeletons primarily rely on a manual control or predefined algorithms for assisting user movements or actions. However, these systems cannot often adapt to the user's intent and real-time needs, limiting their effectiveness, especially for users with varying levels of motor control. Also, due to the manual control or the predefined algorithms, there is a considerable risk of the user falling, which may result in an impactful collision of the user with the ground or a surrounding object. Such incidents not only pose a risk to the user's physical well-being and may also lead to damage to the exoskeleton apparatus. This damage to the exoskeleton apparatus may result in an unpredictable future performance, potentially compromising the user's safety. Furthermore, these conventional exoskeleton apparatuses also restrict the user's mobility and range of motion, thereby preventing them from achieving the full potential benefits of the exoskeleton apparatus.

### BRIEF SUMMARY

An apparatus, a method, and a computer-programmable product are provided herein to assist movement of user wearing exoskeleton apparatus using brain signals of the user.

In one aspect, an exoskeleton apparatus to assist movement of user using brain signals is disclosed. The exoskeleton apparatus includes a memory and a processor communicatively coupled to the memory. The processor may be configured to render a set of images on a display device. Each image of the set of images may be associated with at least one action of a set of actions and fluctuates at a corresponding frequency. The processor may be further configured to receive one or more brain signals associated with a brain of a user based on the rendered set of images. Each of the received one or more brain signals corresponds to an electroencephalography (EEG) signal associated with the brain of the user. The processor may be further configured to determine a first frequency associated with the received one or more brain signals. The processor may be further configured to compare the determined first frequency with a frequency corresponding to each image of the set of images. The processor may be further configured to determine a first action to be performed by the user within a first pre-specified time period based on the comparison. The first action may be included in the set of actions. The processor may be further configured to generate a first set of control signals associated with the determined first action and control one or more actuators embedded within the exoskeleton apparatus based on the generated first set of control signals. The one or more actuators may be controlled to assist the user to perform the first action within the first pre-specified time period.

In additional exoskeleton apparatus embodiments, the one or more brain signals may be received from a wearable device, and the wearable device includes one or more electrodes configured to capture the one or more brain signals.

In additional exoskeleton apparatus embodiments, the wearable device corresponds to at least one of an invasive brain-controlled interface (BCI) wearable device, a partially invasive BCI wearable device, or a non-invasive BCI wearable device.

In additional exoskeleton apparatus embodiments, the wearable device corresponds to at least one of an electroencephalography (EEG) headset, a functional near-infrared spectroscopy (fNIRS) device, an optical brain imaging device, a wearable electrode, a wearable cap, a wearable neurofeedback device, a neuromuscular sensing device, a neurostimulation wearable device, or an eyeglass.

In additional exoskeleton apparatus embodiments, the processor may be configured to provide, as an input, the received one or more brain signals and the generated first set of control signals to a machine learning (ML) model. The ML model may be pre-trained on a historical dataset. The processor may be further configured to generate, based on an output of the ML model, a second set of control signals associated with a second action of the set of actions to be performed by the user within a second pre-specified time period. The second pre-specified time period may be greater than the first pre-specified time period and control the one or more actuators embedded within the exoskeleton apparatus based on the generated second set of control signals. The one or more actuators may be controlled to assist the user to perform the second action within the second pre-specified time period.

In additional exoskeleton apparatus embodiments, the processor may be configured to retrieve the historical dataset including a set of training samples. Each training sample of the set of training samples may include the one or more brain signals, the first action, and the second action performed by the user. The processor may be further configured to train the ML model using the retrieved historical dataset.

In additional exoskeleton apparatus embodiments, the processor may be configured to determine a current location of the user. The processor may be further configured to retrieve, from a map database, one or more customized maps associated with the current location of the user based on the determined current location of the user. The processor may be further configured to generate the first set of control signals associated with the determined first action based on the retrieved one or more customized maps.

In additional exoskeleton apparatus embodiments, each of the one or more customized maps may be associated with at least one point of interest (Pol) associated with the user.

In another aspect, an exoskeleton apparatus to assist movement of user using one or more brain signals is disclosed. The exoskeleton apparatus includes a memory and a processor communicatively coupled to the memory. The processor may be configured to receive one or more brain signals associated with a brain of a user. Each of the received one or more brain signals corresponds to an electroencephalography (EEG) signal associated with the brain of the user. The processor may be configured to generate a first set of control signals associated with a first action to be performed by the user within a first pre-specified time period based on the received one or more brain signals. The first action may be included in a set of actions. The processor may be configured to provide, as an input, the received one or more brain signals and the generated first set of control signals to a machine learning (ML) model. The ML model may be pre-trained on a historical dataset. The processor may be configured to generate a second set of control signals associated with a second action to be performed by the user within a second pre-specified time period based on an output of the ML model. The second action may be included in the set of actions. The processor may be further configured to control one or more actuators embedded within the exoskeleton apparatus based on the generated second set of control signals. The one or more actuators may be controlled to assist the user to perform the second action within the second pre-specified time period.

In additional exoskeleton apparatus embodiments, the one or more brain signals may be received from a wearable device, and the wearable device includes one or more electrodes configured to capture the one or more brain signals.

In additional exoskeleton apparatus embodiments, the wearable device corresponds to at least one of an invasive brain-controlled interface (BCI) wearable device, a partially invasive BCI wearable device, or a non-invasive BCI wearable device.

In additional exoskeleton apparatus embodiments, the wearable device corresponds to at least one of an electroencephalography (EEG) headset, a functional near-infrared spectroscopy (fNIRS) device, an optical brain imaging device, a wearable electrode, a wearable cap, a wearable neurofeedback device, a neuromuscular sensing device, a neurostimulation wearable device, or an eyeglass.

In additional exoskeleton apparatus embodiments, the processor may be configured to retrieve the historical dataset including a set of training samples. Each training sample of the set of training samples may include the one or more brain signals, the first action, and the second action performed by the user and train the ML model using the retrieved historical dataset.

In additional exoskeleton apparatus embodiments, the processor may be configured to render a set of images on a display device. Each image of the set of images may be associated with at least one action of a set of actions and fluctuates at a corresponding frequency. The processor may be further configured to receive the one or more brain signals associated with the brain of the user based on the rendered set of images. The processor may be further configured to determine a first frequency associated with the received one or more brain signals. The processor may be further configured to compare the determined first frequency with a frequency corresponding to each image of the set of images. The processor may be further configured to determine the first action to be performed by the user within a first pre-specified time period based on the comparison. The first action may be included in the set of actions and generate the first set of control signals associated with the determined first action of the set of actions to be performed by the user.

In additional exoskeleton apparatus embodiments, the processor may be configured to determine a current location of the user. The processor may be further configured to retrieve, from a map database, one or more customized maps associated with the current location of the user based on the determined current location of the user and generate, based on the retrieved one or more customized maps, at least one of the first set of control signals or the second set of control signals.

In additional exoskeleton apparatus embodiments, each of the one or more customized maps may be associated with at least one point of interest (Pol) associated with the user.

In yet another embodiment, a method to assist movement of user using one or more brain signals is disclosed. The method includes rendering a set of images on a display device. Each image of the set of images may be associated with at least one action of a set of actions and fluctuates at a corresponding frequency. The method further includes receiving one or more brain signals associated with a brain of a user based on the rendered set of images. Each of the received one or more brain signals corresponds to an electroencephalography (EEG) signal associated with the brain of the user. The method further includes determining a first frequency associated with the received one or more brain signals. The method further includes comparing the determined first frequency with a frequency corresponding to each image of the set of images. The method further includes determining a first action to be performed by the user within a first pre-specified time period based on the comparison. The first action may be included in the set of actions. The method further includes generating a first set of control signals associated with the determined first action and controlling one or more actuators embedded within an exoskeleton apparatus based on the generated first set of control signals. The one or more actuators may be controlled to assist the user to perform the first action within the first pre-specified time period.

In additional method embodiments, the one or more brain signals may be received from a wearable device, and the wearable device includes one or more electrodes configured to capture the one or more brain signals.

In additional method embodiments, the method further includes providing, as an input, the received one or more brain signals and the generated first set of control signals to a machine learning (ML) model. The ML model may be pre-trained on a historical dataset. The method further includes generating, based on an output of the ML model, a second set of control signals associated with a second action of the set of actions to be performed by the user within a second pre-specified time period. The second pre-specified time period may be greater than the first pre-specified time period. The method further includes controlling the one or more actuators embedded within the exoskeleton apparatus based on the generated second set of control signals. The one or more actuators may be controlled to assist the user in performing the second action within the second pre-specified time period.

In additional method embodiments, the method further includes retrieving the historical dataset including a set of training samples. Each training sample of the set of training samples includes the one or more brain signals, the first action, and the second action performed by the user. The method further includes training the ML model using the retrieved historical dataset.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1A is a block diagram that illustrates an exemplary network environment for an exoskeleton apparatus to assist movement of a user using brain signals is implemented, in accordance with an embodiment of the disclosure.

FIG. 1B is a block diagram that illustrates another exemplary network environment in which the exoskeleton apparatus of FIG. 1A is implemented, in accordance with an embodiment of the disclosure.

FIG. 2A is a block diagram of the exoskeleton apparatus of FIG. 1A and FIG. 1B, in accordance with an embodiment of the disclosure.

FIG. 2B is a block diagram of the wearable device of FIG. 1A and FIG. 1B, in accordance with an embodiment of the disclosure.

FIG. 3 is a diagram that depicts an exemplary exoskeleton apparatus, in accordance with an embodiment of the disclosure.

FIG. 4 is a diagram that illustrates exemplary first set of operations of the exoskeleton apparatus to assist movement of user using brain signals, in accordance with an embodiment of the disclosure.

FIG. 5 is a diagram that illustrates exemplary second set operations of the exoskeleton apparatus to assist movement of user using brain signals, in accordance with an embodiment of the disclosure.

FIG. 6 illustrates an exemplary scenario that depicts an exemplary movement of user wearing the exoskeleton apparatus based on the brain signals, in accordance with an embodiment of the disclosure.

FIG. 7 illustrates an exemplary diagram for training and inference of the ML model, in accordance with an embodiment of the disclosure.

FIG. 8 is a first flowchart that illustrates an exemplary first method for assisting movement of user using brain signals, in accordance with some embodiment of the disclosure.

FIG. 9 is a second flowchart that illustrates an exemplary second method for assisting movement of user using brain signals, in accordance with some embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

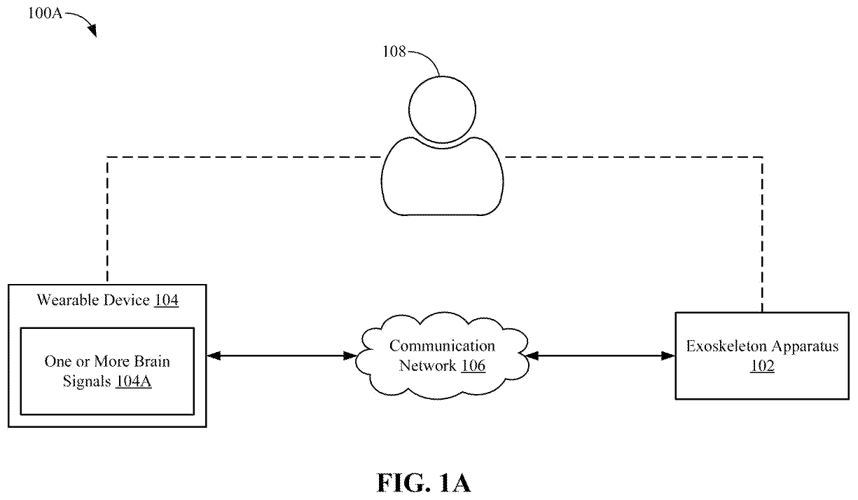

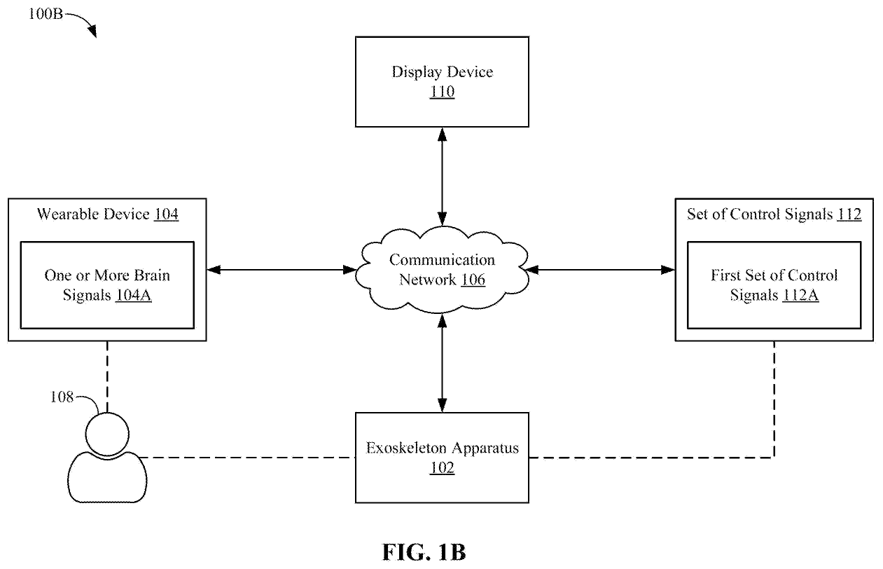

FIG. 1A is a block diagram that illustrates an exemplary network environment 100A for an exoskeleton apparatus 102 to assist movement of a user 108 using brain signals is implemented, in accordance with an embodiment of the disclosure. With reference to FIG. 1A, there is shown the exemplary network environment 100A. The exemplary network environment 100A may include the exoskeleton apparatus 102, a wearable device 104, a communication network 106, and the user 108.

The exoskeleton apparatus 102 may include suitable logic, circuitry, interfaces, and/or code that may be configured to render a set of images on a display device. Each image of the set of images may be associated with at least one action of a set of actions and each image may fluctuate at a corresponding frequency. The exoskeleton apparatus 102 may be further configured to receive one or more brain signals 104A associated with a brain of the user 108 based on the rendered set of images. Each brain signal of the received one or more brain signals 104A may correspond to an electroencephalography (EEG) signal associated with the brain of the user 108. The exoskeleton apparatus 102 may be further configured to determine a first frequency associated with the received one or more brain signals 104A. The exoskeleton apparatus 102 may be further configured to compare the determined first frequency with a frequency corresponding to each image of the set of images. The exoskeleton apparatus 102 may be further configured to determine a first action to be performed by the user 108 within a first pre-specified time period (say within 1 second) based on the comparison. The first action may be included in the set of actions and may correspond to one navigation action of a set of navigation actions such as, but not limited to, moving backward, moving forward, moving left, moving right, or at least one movement action of the set of movement actions such as, but not limited to, sitting, standing, lifting, throwing, and the like.

The exoskeleton apparatus 102 may be further configured to generate a first set of control signals associated with the determined first action and control one or more actuators embedded within the exoskeleton apparatus 102 based on the generated first set of control signals. The one or more actuators may be controlled to assist the user 108 to perform the first action within the first pre-specified time period. Examples of the exoskeleton apparatus 102 may include, but not be limited to, a lower limb exoskeleton, an upper limb exoskeleton, a fully body exoskeleton, a hand exoskeleton, a back exoskeleton, and a neck exoskeleton. Other examples of the exoskeleton apparatus 102 may include, but not limited to, a medical rehabilitation exoskeleton, a military exoskeleton, an industrial exoskeleton, an exosuit for enhanced mobility, an exoskeleton for paraplegics, an exoskeletons for elderly care, an agriculture exoskeletons, and a sports and fitness exoskeleton.

The wearable device 104 may include suitable logic, circuitry, interfaces, and/or code that may be configured to capture the one or more brain signals 104A associated with the brain of the user 108. The one or more brain signals 104A may correspond to the electroencephalography (EEG) signals that may be associated with the brain of the user 108. In an embodiment, the wearable device 104 may be worn by the user 108. Specifically, the wearable device 104 may include one or more electrodes that may be configured to capture the one or more brain signals 104A of the user 108. Each of the captured one or more brain signals 104A may correspond to an electrical pattern of a particular frequency. The electrical pattern may be generated by a synchronized activity of a plurality of neurons in the brain of the user 108. Examples of the wearable device 104 may include, but are not limited to, a headset, an eyeglass, and any other device with the capability to capture the brain signals.

Other examples of the wearable device 104 may include, but not limited to, an invasive brain-controlled interface (BCI) wearable device, a partially invasive BCI wearable device, or a non-invasive BCI wearable device. The invasive BCI wearable device may involve surgically implanting one or more electrodes or sensors directly into the brain tissue of the user 108. The one or more electrodes or sensors may record the neural activity of the brain with high precision. The partially invasive BCI wearable device may combine external sensors with some level of surgical implantation whereas the non-invasive BCI wearable device may not require any surgical implantation and may rely solely on external sensors to detect and interpret brain activity.

Other examples of the wearable device 104 may include, but not limited to, an electroencephalography (EEG) headset, a functional near-infrared spectroscopy (fNIRS) device, an optical brain imaging device, a wearable electrode, a wearable cap, a wearable neurofeedback device, a neuromuscular sensing device, a neurostimulation wearable device, or an eyeglass.

The communication network 106 may include a communication medium through which the exoskeleton apparatus 102 and the wearable device 104 may communicate with each other. The communication network 106 may be one of a wired connection or a wireless connection. Examples of the communication network 106 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the exemplary network environment 100A may be configured to connect to the communication network 106 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

FIG. 1B is a block diagram that illustrates another exemplary network environment 100B in which the exoskeleton apparatus 102 of FIG. 1 is implemented, in accordance with an embodiment of the disclosure. With reference to FIG. 1B, there is shown the exemplary network environment 100B. The exemplary network environment 100B may include the exoskeleton apparatus 102, the wearable device 104, the communication network 106, the user 108, a display device 110, and a set of control signals 112.

The display device 110 may include suitable logic, circuitry, and interfaces that may be configured to display the set of images to the user 108. In some embodiments, the display device 110 may be an external display device associated with the exoskeleton apparatus 102. The display device 110 may be a touch screen which may enable the user 108 to provide the user input, for example, the set of images, via the display device 110. The touch screen may be at least one of a resistive touch screen, a capacitive touch screen, or a thermal touch screen. The display device 110 may be realized through several known technologies such as, but are not limited to, at least one of a Liquid Crystal Display (LCD) display, a Light Emitting Diode (LED) display, a plasma display, or an Organic LED (OLED) display technology, or other display devices. In accordance with an embodiment, the display device 110 may refer to a display screen of a head mounted device (HMD), a smart-glass device, a see-through display, a projection-based display, an electro-chromic display, or a transparent display, and/or a medical imaging display.

In operation, the user 108 may be a person who may use the exoskeleton apparatus 102 to assist their movement(s) or action(s). Once operational and worn by the user, the exoskeleton apparatus 102 may be configured to render the set of images on the display device 110. Each image of the set of images may be associated with at least one action of the set of actions in which the user might require assistance and each image may fluctuate at its corresponding frequency which may be different from the frequency of other images of the set of images.

Based on the rendered set of images, the exoskeleton apparatus 102 may be further configured to receive the one or more brain signals 104A associated with the brain of the user 108. In an embodiment, the one or more brain signals 104A may be received from the wearable device 104 worn by the user 108, via the communication network 106. As discussed above, each brain signal of the one or more brain signals 104A may correspond to an electrical pattern that may be generated by the synchronized activity of the plurality of neurons in the brain of the user 108, which may communicate with each other through one or more electrochemical impulses.

The exoskeleton apparatus 102 may be further configured to determine the first frequency associated with the received one or more brain signals 104A. Each of the received one or more brain signals 104A may have a corresponding frequency and amplitude that may vary depending on a mental state of the user 108, such as, but not limited to, concentration, relaxation, or sleep. In an embodiment, the first frequency may be determined based on a visual scene seen by the user 108 such as the set of images seen by the user 108. In another embodiment, the first frequency may be determined based on at least one of an audio heard by the user 108, a thought of the user 108, and or a muscular movement of the user 108.

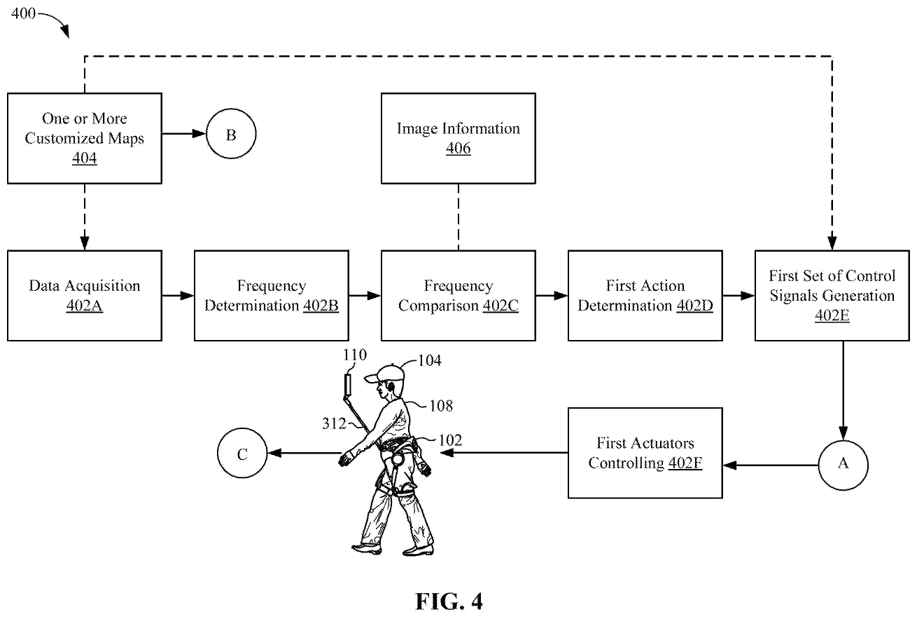

The exoskeleton apparatus 102 may be further configured to compare the determined first frequency with the frequency corresponding to each image of the set of images. The frequency of each of the set of images may be measured in Hertz (Hz), which represents the number of cycles or changes per second associated with the corresponding image. For example, an image's corresponding frequency of 10 Hz indicates that the image may fluctuate or change its appearance 10 times every second. In one embodiment, the comparison may be performed between the determined first frequency and the corresponding frequency of each of the set of images to determine, whether the determined first frequency may be equal or approximately equal to the corresponding frequency of one of the set of images. Details about the determination are provided, for example, in FIG. 4.

The exoskeleton apparatus 102 may be further configured to determine the first action to be performed by the user 108 within the first pre-specified time period based on the comparison. The first action may be included in the set of actions. Specifically, the first action may include one of the set of actions that one of the set of images may be visualizing on the display device 110. The set of actions may include one navigation action of the set of navigation actions such as, but not limited to, moving backward, moving forward, moving left, moving right, or one movement action of the set of movement actions such as, but not limited to, sitting, standing, stretching, lifting, throwing, and the like.

The exoskeleton apparatus 102 may be further configured to generate the first set of control signals 112A associated with the determined first action. In one embodiment, the first set of control signals 112A may be generated based on the determined first action and may indicate attributes (such as an angle, a speed, or a position) associated with the one or more actuators embedded with the exoskeleton apparatus 102. The exoskeleton apparatus 102 may transmit the first set of control signals 112A to the embedded one or more actuators. Details about the generation of the first set of control signals 112A are provided, for example, in FIG. 4.

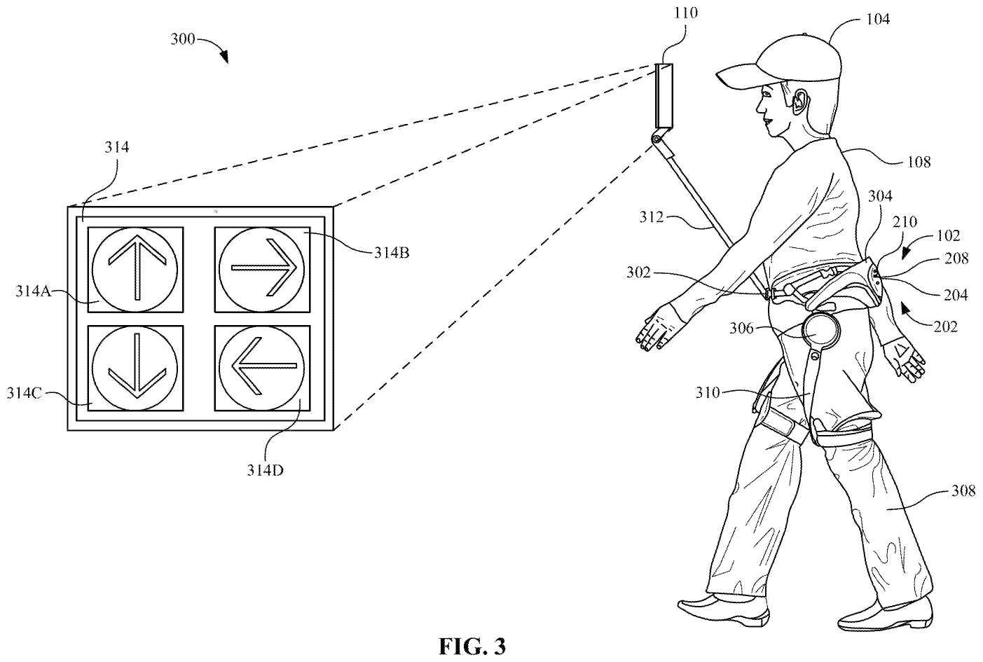

The exoskeleton apparatus 102 may be further configured to control the one or more actuators embedded within the exoskeleton apparatus 102 based on the generated first set of control signals 112A. The one or more actuators may be controlled to assist the user 108 to perform the first action within the first pre-specified time period. The exoskeleton apparatus 102 may be further configured to adjust the embedded one or more actuators according to the first set of control signals 112A such that the exoskeleton apparatus 102 may assist the user 108 to perform the first action. Details about the one or more actuators embedded within the exoskeleton apparatus 102 are provided, for example, in FIG. 3.

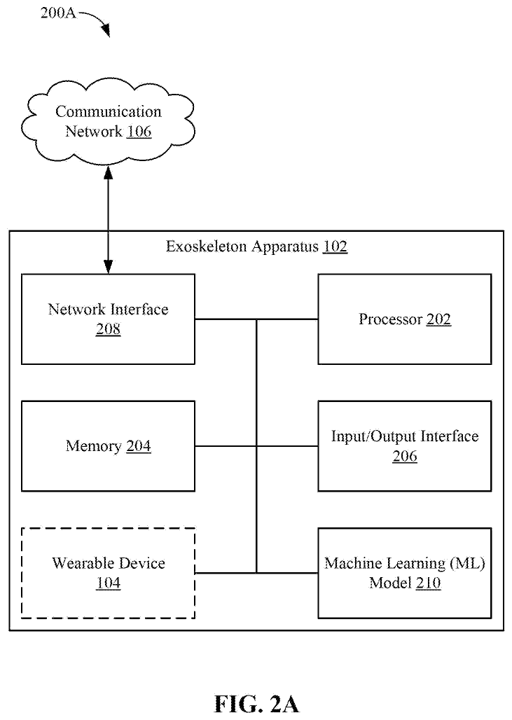

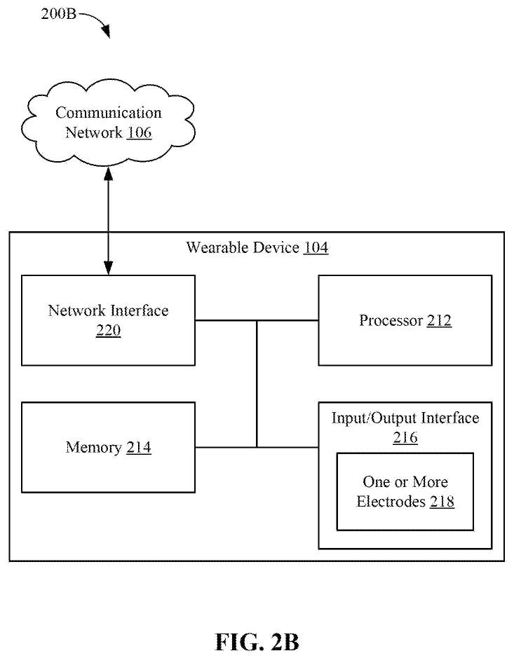

FIG. 2A is a block diagram 200A of the exoskeleton apparatus 102 of FIG. 1 and FIG. 1B, in accordance with an embodiment of the disclosure. FIG. 2A is explained in conjunction with elements from FIG. 1A and FIG. 1B. With reference to FIG. 2A, there is shown a block diagram 200A of the exoskeleton apparatus 102. The exoskeleton apparatus 102 may include a processor 202, a memory 204, an input/output interface 206, a network interface 208, and a machine learning (ML) model 210. In an embodiment, the exoskeleton apparatus 102 may also include the wearable device 104. The processor 202 may be communicatively coupled to the memory 204, the input/output interface 206, the network interface 208, the ML model 210, and the wearable device 104.

The processor 202 may include suitable logic, circuitry, and/or interfaces that may be configured to execute program instructions associated with different operations to be executed by the exoskeleton apparatus 102. The processor 202 may be configured to render the set of images, receive the one or more brain signals 104A, determine the first frequency, compare the determined frequency with the corresponding frequency of each of the set of images, determine of the first action, generate the first set of control signals 112A, and control the one or more actuators. The processor 202 may include one or more specialized processing units, which may be implemented as an integrated processor or a cluster of processors that perform the functions of the one or more specialized processing units collectively. The processor 202 may be implemented based on a number of processor technologies known in the art. Examples of implementations of the processor 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, and/or interfaces that may be configured to store program instructions to be executed by the processor 202. The memory 204 may be further configured to store a plurality of processor-executable instructions to be executed by the exoskeleton apparatus 102. The memory 204 may be further configured to store the set of images, one or more customized maps, and the received one or more brain signals 104A. In another embodiment, the memory 204 may be further configured to store the information associated with the set of actions in which the user 108 may require assistance. Examples of implementations of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The input/output (I/O) interface 206 may include suitable logic, circuitry, interfaces, and/or code that may be configured to receive an input and provide an output based on the received input. The I/O interface 206 may include various input and output devices, which may be configured to communicate with the processor 202. For example, the exoskeleton apparatus 102 may receive the one or more brain signals 104A via the I/O interface 206. The I/O interface 206 may include various input and output devices, which may be configured to communicate with different operational components of the exoskeleton apparatus 102. Examples of the I/O interfaces 206 may include, but are not limited to, a touch screen, a keyboard, a mouse, a joystick, a microphone, and a display device (such as the display device 110).

The network interface 208 may include suitable logic, circuitry, interfaces, and/or code that may be configured to establish communication between the exoskeleton apparatus 102, the wearable device 104, the display device 110, and the ML model 210 via the communication network 106. The network interface 208 may be configured to implement known technologies to support wired or wireless communication. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 208 may be configured to communicate via offline and online wireless communication with networks, such as the Internet, an Intranet, and/or a wireless network, such as a cellular telephone network, a wireless local area network (WLAN), a personal area network (PAN), and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), LTE, time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VOIP), Wi-MAX, Internet-of-Things (IoT) technology, Machine-Type-Communication (MTC) technology, a protocol for email, instant messaging, and/or Short Message Service (SMS).

The ML model 210 may be a neural network. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on a training dataset. Each node of the neural network may correspond to a mathematical function (e.g., a sigmoid function or a rectified linear unit) with a set of parameters, tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different same mathematical function.

In training of the neural network, one or more parameters of each node of the neural network may be updated based on whether an output of the final layer for a given input (from a training dataset) matches a correct result based on a loss function for the neural network. The above process may be repeated for the same or a different input until a minimum of loss function may be achieved, and a training error may be minimized. Several methods for training are known in art, for example, gradient descent, stochastic gradient descent, batch gradient descent, gradient boost, meta-heuristics, and the like.

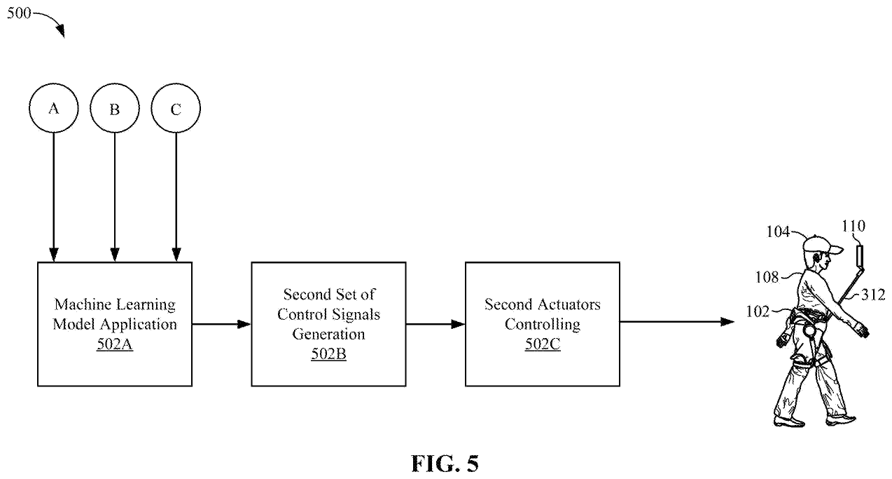

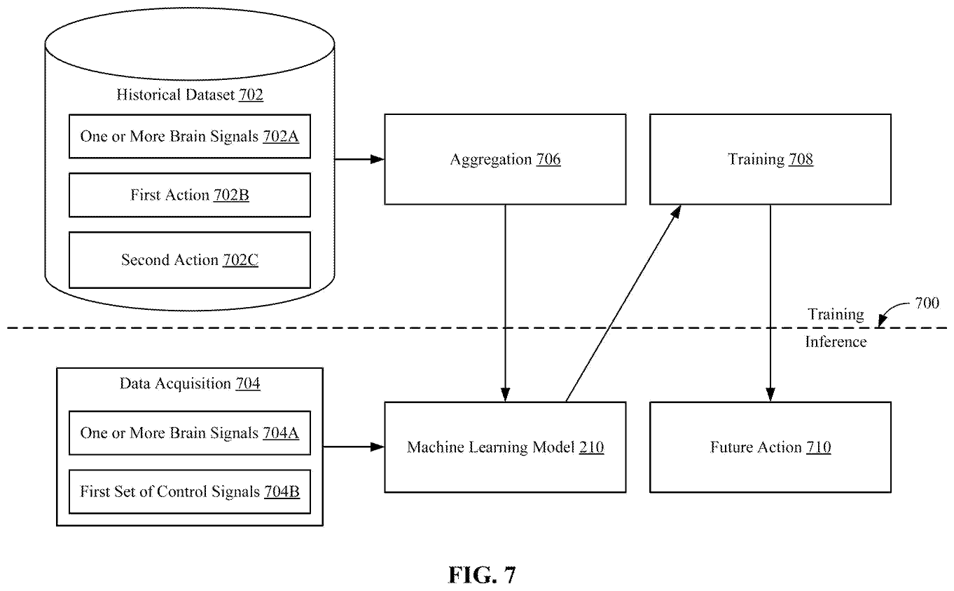

The neural network may include electronic data, such as, for example, a software program, code of the software program, libraries, applications, scripts, or other logic or instructions for execution by a processing device, such as circuitry. The neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software. Although in FIG. 2A, the neural network is shown integrated within the exoskeleton apparatus 102, the disclosure is not so limited. Accordingly, in some embodiments, the neural network may be a separate entity in the exoskeleton apparatus 102, without deviation from scope of the disclosure. Details about the ML model are provided, for example, in FIG. 5 and FIG. 7.

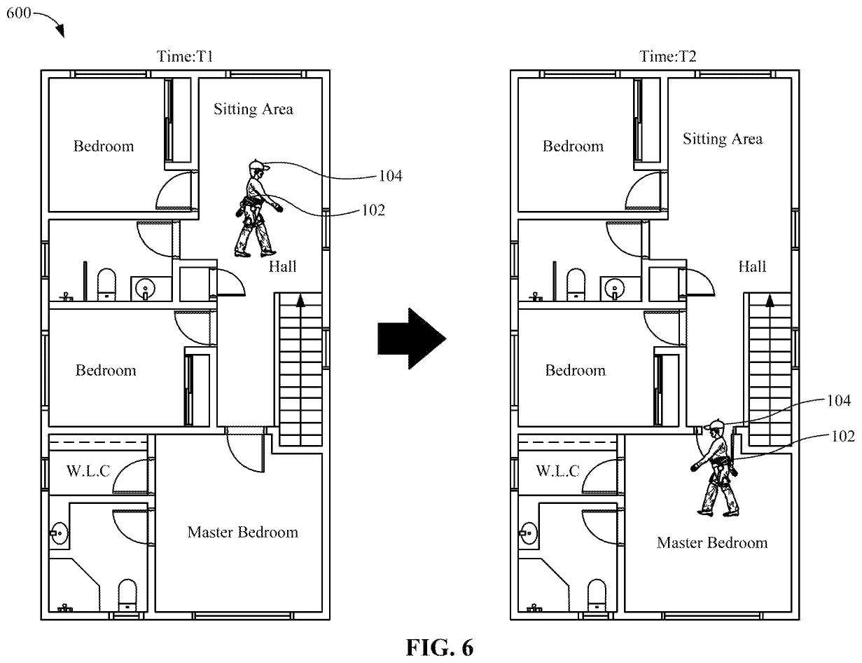

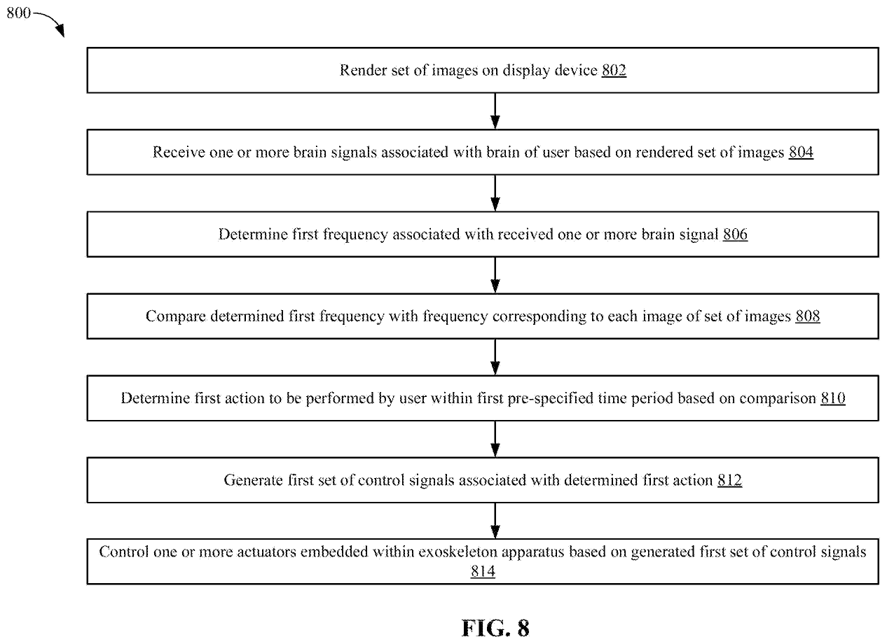

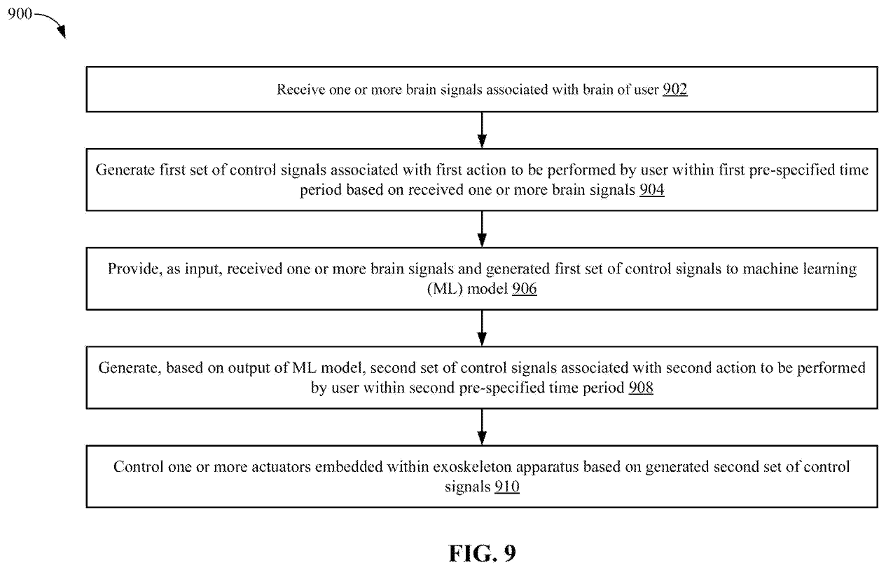

The functions or operations executed by the exoskeleton apparatus 102, as described in FIG. 1A and FIG. 1B, may be performed by the processor 202. Operations executed by the processor 202 are described in detail, for example, in FIG. 3, FIG. 4, FIG. 5, FIG. 6, FIG. 7, FIG. 8, and FIG. 9.

FIG. 2B is a block diagram 200B of the wearable device 104 of FIG. 1A and FIG. 1B, in accordance with an embodiment of the disclosure. FIG. 2B is explained in conjunction with elements from FIG. 1A, FIG. 1B and FIG. 2A. With reference to FIG. 2B, there is shown a block diagram 200B of the wearable device 104. The wearable device 104 may include a processor 212, a memory 214, an input/output interface 216 that may further include one or more electrodes 218, and a network interface 220. The processor 212 may be communicatively coupled to the memory 214, the input/output interface 216, the one or more electrodes 218, and the network interface 220.

The processor 212 may include suitable logic, circuitry, and/or interfaces that may be configured to execute program instructions associated with different operations to be executed by the wearable device 104. The processor 212 may be configured to capture the one or more brain signals 104A. The processor 212 may be further configured to transmit the captured one or more brain signals 104A to the exoskeleton apparatus 102. The processor 212 may include one or more specialized processing units, which may be implemented as an integrated processor or a cluster of processors that perform the functions of the one or more specialized processing units, collectively. The processor 212 may be implemented based on a number of processor technologies known in the art. Examples of implementations of the processor 212 may be the x86-based processor, the GPU, the RISC processor, the ASIC processor, the CISC processor, the microcontroller, the CPU, and/or other computing circuits.

The memory 214 may include suitable logic, circuitry, and/or interfaces that may be configured to store program instructions to be executed by the processor 212. The memory 214 may be further configured to store a plurality of processor-executable instructions to be executed by the wearable device 104. The memory 214 may be further configured to store the captured one or more brain signals 104A. Examples of implementations of the memory 214 may include, but are not limited to, the RAM, the ROM, the EEPROM, the HDD, the SSD, the CPU cache, and/or the SD card.

The input/output (I/O) interface 216 may include suitable logic, circuitry, interfaces, and/or code that may be configured to receive an input and provide an output based on the received input. The I/O interface 206 may include various input and output devices, which may be configured to communicate with the processor 212, and the one or more electrodes 218. For example, the wearable device 104 may transmit the one or more brain signals 104A via the I/O interface 216. The I/O interface 216 may comprise various input and output devices, which may be configured to communicate with different operational components of the wearable device 104. Examples of the I/O interfaces 216 may include, but are not limited to, the touch screen, the keyboard, the mouse, the joystick, the microphone, and the display screen.

The network interface 220 may include suitable logic, circuitry, interfaces, and/or code that may be configured to establish communication between the exoskeleton apparatus 102, and the wearable device 104 via the communication network 106. The network interface 220 may be configured to implement known technologies to support wired or wireless communication. The network interface 220 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 220 may be configured to communicate via offline and online wireless communication with networks, such as the Internet, the Intranet, and/or the wireless network, such as the cellular telephone network, the WLAN, the personal area network, and/or the MAN. The wireless communication may use any of a plurality of communication standards, protocols and technologies, such as the GSM, the EDGE, the W-CDMA, the CDMA, the LTE, the TDMA, the Bluetooth, the Wi-Fi (such as IEEE 802.11, IEEE 802.11b, IEEE 802.11g, IEEE 802.11n, and/or any other IEEE 802.11 protocol), the VoIP, the Wi-MAX, the IoT technology, the MTC technology, the protocol for email, the instant messaging, and/or the SMS.

In an embodiment, the user 108 may be wearing the wearable device 104. In one example embodiment, the user 108 may place the wearable device 104 on the scalp of the user 108. Once placed on the scalp, the exoskeleton apparatus 102 may be configured to control the one or more electrodes 218 of the wearable device 104 to capture the one or more brain signals 104A of the user 108. In some other embodiments, the wearable device 104 may receive the one or more brain signals 104A from the one or more electrodes 218 as soon as the one or more electrodes 218 may be placed on the scalp of the user 108. As discussed above, the captured one or more brain signals 104A may correspond to the EEG signal associated with the brain of the user 108. The wearable device 104 may be further configured to transmit the captured one or more brain signals 104A via the I/O interface 216 to the exoskeleton apparatus 102.

FIG. 3 is a diagram 300 that depicts an exemplary exoskeleton apparatus, in accordance with an embodiment of the disclosure. FIG. 3 is explained in conjunction with elements from FIG. 1A, FIG. 1B, FIG. 2A, and FIG. 2B. With reference to FIG. 3, there is shown the diagram 300 that depicts the exoskeleton apparatus 102.

The exoskeleton apparatus 102 may feature a harness 302. The harness 302 may be worn around a waist of the user 108 of the exoskeleton apparatus 102. The harness 302 may have a housing 304 that may house two motors 306. Each of the two motors 306 may be positioned concentric with an axis of each hip joint. Each of the two motors 306 may exert torque on legs 308 of the user 108 through one or more actuators 310 embedded with the exoskeleton apparatus 102. The one or more actuators 310 may be coupled to the thighs of the user 108. The one or more actuators 310 may be formed of a rigid and a lightweight material. This configuration may make the exoskeleton apparatus 102 effective in assisting a swing phase of a walking cycle as well as other leg movements not involving ground contact.

In an embodiment, the processor 202 may be positioned within the housing 304. The processor 202 may be used to control the operation of the exoskeleton apparatus 102. The processor 202 may include the ML model 210 and may be connected to the network interface 208 as described above. The processor 202 may store a computer program or other programming instructions associated with the memory 204 to control the operations of the exoskeleton apparatus 102.

A display support assembly 312 may be provided to show the display device 110 ahead of the face of the user 108. In an embodiment, a first end of the display support assembly 312 may be attached to the harness 302 of the exoskeleton apparatus 102, and a second end of the display support assembly 312 may include a fixing support assembly. The fixing support assembly may clamp the display device 110.

The display device 110 may render a set of images 314 to the user 108. Each image of the set of images 314 may be associated with at least one action of the set of actions and may fluctuate at the corresponding frequency. The frequency may correspond to a rate of change in an appearance of a respective image of the set of images 314. As shown on the display device 110, the set of images 314 may include a first image 314A indicating a navigation action of moving forward, a second image 314B indicating the navigation action of moving right, a third image 314C indicating the navigation action of moving backward, and a fourth image 314D indicating the navigation action of moving left.

In an embodiment, each of the set of images 314 may fluctuate at its corresponding frequency, for example, the first image 314A visualizing the moving forward action may be fluctuating at 10 Hz, the second image 314B visualizing the move right action may be fluctuating at 12 Hz, the third image 314C visualizing the move backward action may be fluctuating at 15 Hz, and the fourth image 314D visualizing the move left action may be fluctuating at 18 Hz. In an embodiment, the corresponding frequency may be used to determine the first action to be performed by the user 108 within the pre-specified time period. In an example, the processor 202 may be configured to determine the first frequency associated with the received one or more brain signals 104A. Continuing with the present example, the determined first frequency may indicate a frequency of 17 Hz (approximately equal to 18 Hz). The processor 202 may be further configured to compare the determined first frequency with the corresponding frequency of each of the set of images 314. In one embodiment, to compare the first frequency with the corresponding frequency of each of the set of images 314, the processor 202 may be configured to determine, if the first frequency may be equal or approximately equal to the correspond frequency of any image of the set of images 314. Continuing with the present example, the corresponding frequency of the fourth image 314D may be equal to the first frequency. The processor 202 may be further configured to determine the first action to be performed by the user 108 within the pre-specified time period based on the comparison. Based on the comparison in which the first frequency may be equal to the corresponding frequency of fourth image 314D, the processor 202 may be further configured to obtain the associated action of the image 314 as the first action which may be the move left action. The first action may be performed by the user 108 within the pre-specified time period (e.g. within the next 10 seconds from a current time). Details about the determination of the first action are provided, for example, in FIG. 4.

FIG. 4 is a diagram that illustrates an exemplary first set of operations of the exoskeleton apparatus 102 to assist movement of user 108 using brain signals, in accordance with an embodiment of the disclosure. FIG. 4 is explained in conjunction with elements from FIG. 1A, FIG. 1B, FIG. 2A, FIG. 2B, and FIG. 3. With reference to FIG. 4, there is shown a block diagram 400 that illustrates exemplary operations from 402A to 402F, as described herein. The exemplary operations illustrated in block diagram 400 may start at 402A and may be performed by any computing system, apparatus, or device, such as by the exoskeleton apparatus 102 of FIG. 1A or FIG. 1B or the processor 202 of FIG. 2A. Although illustrated with discrete blocks, the exemplary operations associated with one or more blocks of the block diagram 400 may be divided into additional blocks, combined into fewer blocks, or eliminated, depending on the particular implementation.

At 402A, a data acquisition operation is performed. In the data acquisition operation, the processor 202 may be configured to render the set of images 314 on the display device 110. Each image of the set of images 314 may be associated with at least one action of the set of actions and may fluctuate at the corresponding frequency. The set of actions may be associated with at least one of the navigation actions, movement actions, or the like. Examples of the navigation actions may include, but not limited to, moving backward, moving forward, moving left, moving right. Examples of the movement actions may include, but not limited to, sitting, standing, lifting, throwing, and the like.

In an embodiment, the processor 202 may be further configured to receive the one or more brain signals 104A associated with the brain of the user 108 after the set of images 314 may be rendered on the display device 110. The user 108 may have to perform at least one action of the set of actions displayed on the set of images 314. To perform that action the user 108 may look at the corresponding image depicting the action. For example, if the user 108 may have to move forward, the user 108 may look at the first image 314A. Similarly, if the user 108 wishes to move left, the user 108 may look at the fourth image 314D.

As soon as the user 108 looks at one of the set of images 314, the processor 202 may capture the one or more brain signals 104A of the user 108. Each of the received one or more brain signals 104A corresponds to the EEG signal associated with the brain of the user 108. Each of the one or more brain signals 104A may be an electrical signal that may be generated by the brain by a collective activity of the plurality of neurons of the human nervous system. In an embodiment, the one or more brain signals mat correspond to electrical signals that may be generated by the flow of charged ions (such as sodium, potassium, and calcium) across the cell membranes of neurons. Such signals may be measured using electroencephalography (EEG), which may be a method to record an electro gram of the spontaneous electrical activity of the brain. In one or more embodiments, each of the one or more brain signals 104A may be visualized as a graph between a voltage versus and a time graph.

In an embodiment, the processor 202 may be configured to control the wearable device 104 to capture the one or more brain signals 104A associated with the brain of the user 108. The wearable device 104 may be further configured to transmit the captured one or more brain signals 104A to the exoskeleton apparatus 102 via the communication network 106. The captured one or more brain signals may be generated in the brain of the user 108, when the user 108 may be looking at one of the set of images 314.

In an embodiment, the processor 202 may be further configured to determine a current location of the user 108. In an embodiment, the processor 202 may be configured to determine the current location of the user 108 using various localization and tracking methods, for example, a global positioning system (GPS), an indoor positioning system (IPS), an inertial measurement units (IMUs), a Visual tracking, an ultrasonic and infrared sensors, a beacon-based systems, a magnetic field mapping, a laser-based systems, and a simultaneous localization and mapping (SLAM). In one embodiment, the processor 202 may select one of the localization methods based on a factor such as the indoor or outdoor nature of the environment around the user 108. Specifically, the indoor positioning system (IPS) may be selected, if the user 108 may be surrounded by an indoor environment such as ‘home’. Alternatively, the global positioning system (GPS) may be selected, if the user 108 may be surrounded by an outdoor environment such as a ‘shopping mall’.

Based on the determination of the current location of the user 108, the processor 202 may be further configured to retrieve one or more customized maps 404 associated with the current location of the user 108 from a map database. The one or more customized maps 404 may be stored in a map database that may be accessible via the communication network 106. The one or more customized maps 404 may be associated with the current location of the user 108, for example, if the determined current location of user 108 may be ‘home’, the one or more customized maps 404 may indicate detailed information associated with the ‘home’ location of the user 108. In an example, the one or more customized maps 404 for ‘home’ location may indicate information, for example, first bedroom, sitting area, hall, second bedroom, master bedroom, kitchen, main entrance, back entrance, washroom, and the like. In another example, the one or more customized maps 404 may indicate the information, for example, markers or icons representing nearby points of interest such as, but not limited to, restaurants, shops, public transportation stations, hospitals, landmarks, and route information such as a visual representation of the planned route from a current location of the user 108 to their destination location. The one or more customized maps 404 may further include information, for example, street names and labels, traffic and congestion data, public transportation, accessible information, amenities and services, weather conditions, local events, health and safety, custom notes and annotations, geographical features, language and localization, historical and cultural information, user location and orientation, and interactive features.

At 402B, a frequency determination operation is performed. In the frequency determination operation 402B, the processor 202 may be configured to determine the first frequency associated with the received one or more brain signals 104A. The determined first frequency may indicate a rate at which captured one or more brain signal repeats or cycles over a specific unit of time. In general, the frequency may be measured in Hertz (Hz), for example, 1 Hertz represents one cycle per second.

In an exemplary embodiment, to determine the first frequency associated with the received one or more brain signals 104A, the processor 202 may be configured to transform a time-domain EEG signals (or the one or more brain signals) into a frequency domain EEG signals using techniques such as Fourier analysis. The processor 202 may further determine the first frequency from the frequency domain EEG signals. Details about the determination of the first frequency from the frequency domain EEG signals are known in the art and therefore have been omitted for the sake of brevity.

At 402C, a frequency comparison operation is performed. In the frequency comparison operation 402C, the processor 202 may be configured to obtain image information 406 of each of the set of images 314. The obtained image information 406 may be predetermined for each of the set of images 314. In an exemplary embodiment, the image information 406 may include a list of parameters such as the visuals of the image, the corresponding frequency of the image, and the associated action of the image. Exemplary image information 406 of each of the set of images 314 is shown in Table 1.

TABLE 1
Image Information

| Image Serial Number | Visual | Frequency | Associated action |
|---|---|---|---|
| First Image 314A | Move Forward | 10 Hz | Move Forward |
| Second Image 314B | Move Right | 12 Hz | Move Right |
| Third Image 314C | Move Backward | 15 Hz | Move Backward |
| Fourth Image 314D | Move Left | 18 Hz | Move Left |

As shown in the table T1, the first image 314A associated with the action of moving forward may fluctuate at 10 Hz, the second image 314B associated with the action of moving right may fluctuate at 12 Hz, the third image 314C associated with the third action of moving backward may be fluctuating at 15 Hz, and the fourth image 314D associated with the action of moving left may be fluctuating at 18 Hz. In an exemplary embodiment, the moving forward action may indicate that the exoskeleton apparatus 102 may assist the user 108 to move in a forward direction, upon execution. Similarly, each of the associated actions may indicate a respective direction or other movements (such as sitting, throwing, and the like).

In an embodiment, the processor 202 may be further configured to compare the determined first frequency with the corresponding frequency of each of the set of images 314. This may be done because when the user 108 looks at one of the set of images 314 fluctuating at a particular frequency, then the one or more brain signals associated with the brain of the user 108 may have the same (or nearly the same) frequency as that of the image at which the user 108 may be looking at.

In an embodiment, the processor 202 may obtain the frequency associated with each of the set of images 314 may be from the image information that may be stored in the memory 204. The processor 202 may be further configured to compare the determined first frequency with the corresponding frequency of each of the set of images 314.

At 402D, a first action determination operation is performed. In the first action determination operation 402D, the processor 202 may be configured to determine the first action to be performed by the user 108 within the first pre-specified time period. In an embodiment, the first action may be determined based on the comparison of the determined first frequency with the frequency corresponding to each image of the set of images 314. In an embodiment, the processor 202 may determine the first action by selecting an associated action of an image of the set of images 314 which may fluctuate at a frequency same as the determined first frequency. Specifically, the processor 202 may be configured to select the associated action of the image of the set of images 314 as the first action, if the corresponding frequency of the image may be equal or approximately equal to the determined first frequency. For example, if the determined first frequency of the one or more brain signals 104A is 10 Hz, then the action of moving forward associated with the first image 314A may be selected as the first action. As another example, if the determined first frequency of the one or more brain signals 104A is 17 Hz, then the action of moving left associated with the fourth image 314D may be selected as the first action.

At 402E, the first set of control signals generation operation is performed. In the first set of control signals generation operation 402E, the processor 202 may be configured to generate the first set of control signals 112A associated with the determined first action. In one embodiment, the first set of control signal 112A may be associated with a movement of the one or more actuators 310, such as those coupled at the thighs, knees, and ankles of the user 108. Specifically, the first set of control signals 112A may indicate an angle or a position (or other parameters) of each of the one or more actuators 310 to assist the user 108 to walk, stand up, stand down, or do other movements/actions. In another embodiment, the first set of control signals 112A may indicate motor commands. The motor commands may be used to actuate the movement of the one or more actuators 310. For example, the motor commands may instruct one of the two motors 306 to rotate clockwise to actuate the one or more actuators 310. In another example, if the associated action may be the move left action, the first set of control signals 112A may indicate the motor commands to rotate the two motors 306 at the speed or the direction to actuate the one or more actuators 310 at the angle used to assist the movement of the user 108 in the left direction.

In another embodiment, the processor 202 may be further configured to generate the first set of control signals 112A associated with the determined first action further based on the retrieved one or more customized maps 404. In one embodiment, the processor 202 may perform a route planning for the user 108 based on the retrieved one or more customized maps 404. Specifically, the processor 202 may be further configured to perform the route planning and generate a route for the user 108 based on the one or more customized maps 404 associated with the determined first action, the current location, and the destination location of the user 108. Further, the processor 202 may generate the first set of control signals 112A based on the generated route and the determined first action. The first set of control signals 112A may indicate the motor commands or joint movements required to rotate the two motors 306 at the speed or direction to actuate the one or more actuators 310 at the angle used to execute the one or more movements of the user 108 to follow the generated route. The one or more movements may assist the user 108 to stay at the generated route and reach to the destination location.

At 402F, a first actuators controlling operation is performed. In the first actuators controlling operation 402F, the processor 202 may be configured to control the one or more actuators 310 embedded within the exoskeleton apparatus 102 based on the generated first set of control signals 112A. The one or more actuators 310 may be controlled to assist the user 108 to perform the first action within the first pre-specified time period. In an example, the first action may indicate, for example, going to the master bedroom, sitting on a chair, dancing, going to the shopping mall, and the like. The first pre-specified time period may be a time range in which the 108 may perform the first action.

In an example, the exoskeleton apparatus 102 may assist the user 108 to do what the user 108 may be thinking. As an example, the user may be thinking about picking up an item. The exoskeleton apparatus 102 may determine that the first action may be to perform an action of picking up an item within the first pre-specified time period. Continuing with the present example, the first pre-specified time period may be a time range of 2 seconds from a current time. The exoskeleton apparatus 102 may assist the user 108 to pick the item within the time range of 2 seconds from the current time. In one embodiment, the processor 202 may be configured to transmit the first set of control signals 112A to the two motors 306 via the communication network 106. The first set of control signal 112A may include the motor commands such as a speed, a direction, a position, a rotation or a force which may be used to control the one or more actuators 310. Once the first set of control signals 112A may be received by the two motors 306 of the exoskeleton apparatus 102, the two motors 306 may generate mechanical motion or force as instructed in the first set of control signals 112A. The mechanical motion may be performed to control the mobility of the exoskeleton apparatus 102 using the one or more actuators 310 to assist the user 108 to pick up the item.

FIG. 5 is a diagram that illustrates exemplary second set operations of the exoskeleton apparatus 102 to assist movement of user 108 using brain signals, in accordance with an embodiment of the disclosure. FIG. 5 is explained in conjunction with elements from FIG. 1A, FIG. 1B, FIG. 2A, FIG. 2B, FIG. 3 and FIG. 4. With reference to FIG. 5, there is shown a block diagram 500 that illustrates exemplary operations from 502A to 502C, as described herein. The exemplary operations illustrated in block diagram 500 may start at 502A and may be performed by any computing system, apparatus, or device, such as by the exoskeleton apparatus 102 of FIG. 1A and FIG. 1B or the processor 202 of FIG. 2A. Although illustrated with discrete blocks, the exemplary operations associated with one or more blocks of the block diagram 500 may be divided into additional blocks, combined into fewer blocks, or eliminated, depending on the particular implementation.

In an embodiment, the disclosed exoskeleton apparatus 102 may be able to predict future actions to be performed by the user 108 based on the current action of the user 108. In such an embodiment, the ML model 210 may provide an improved user experience by anticipating the user's intentions and movements and further creating a more intuitive and responsive interaction between the user 108 and the exoskeleton apparatus 102. Further, by predicting the future action(s) of the user 108 using the ML model 210, the exoskeleton apparatus 102 may proactively assist or adjust its support to make the future action(s) more efficient and comfortable. Further, the ML model 210 may help in preventing accidents or falls by detecting potential hazards in advance and by taking preventive measures. The exoskeleton apparatus 102 may execute the below mentioned operations from 502A to 502C to predict the future action(s) of the user 108.

At 502A, an ML model application operation is performed. In the ML model application operation 502A, the processor 202 may be configured to provide, as an input, the received one or more brain signals 104A, the retrieved one or more customized maps 404, and the generated first set of control signals 112A to the ML model 210. The ML model 210 may be pre-trained on a historical dataset. The one or more brain signals 104A may be received from the wearable device 104 that may be worn by the user 108. The one or more customized maps 404 may be stored on the map database, accessible via the communication network 106. The one or more customized maps 404 may be associated with the current location of the user 108. For example, if the current location of user 108 may be a ‘home’ location, the one or more customized maps 404 may indicate information associated with the ‘home’ location of the user 108. In an embodiment, the first set of control signals 112A may indicate a current angle or a current position of each of the one or more actuators 310 to assist the user 108 to walk, stand up, stand down, or other movements.

The processor 202 may be configured to input the retrieved one or more customized maps 404 to the ML model 210. The processor 202 may be further configured to input the first set of control signals 112A. The first set of control signals 112A may indicate information, for example, the current angle and the current position of the one or more actuators 310.

Consider an example, after performing the first action within the first pre-specified time period, the angle of the one or more actuators 310 may be at 35 degrees, and in order to perform the second action in the second pre-specified time period, the one or more actuators 310 may be required to move at 70 degree. Based on the information of the angle of the one or more actuators 310 in the first time period, the ML model 210 may generate the second set of control signals to indicate the one or more actuators 310 move at the angle of 35 degrees within the second pre-specified time period. This may lead the one or more actuators 310 to achieve the angle of 70 degrees within the second set of control signals. Utilizing the real-time information related to the one or more actuators 310 may lead the exoskeleton apparatus 102 to move safely and reliably.

Based on the received input, the ML model 210 may be configured to determine a second action of the set of actions to be performed by the user 108 within the second pre-specified time period. In another embodiment, the ML model 210 may be further configured to determine the second set of control signals associated with the second action to be performed by the user 108 within the second pre-specified time period.

At 502B, a second set of control signals generation operation is performed. In the second set of control signals generation operation 502B, the processor 202 may be configured to generate, based on an output of the ML model 210, the second set of control signals associated with the second action of the set of actions to be performed by the user 108 within the second pre-specified time period. The second pre-specified time period may be greater than the first pre-specified time period. In an embodiment, the processor 202 may be further configured to generate the second set of control signals based on the provided input, for example, the one or more brain signals 104A.

In an example, to generate the second set of control signals, the ML model 210 may recognize patterns in the received one or more brain signals 104A and map them to specific future commands or future actions such as the second action.

In another example, the ML model 210 may be trained on the historical dataset of one or more events related to the relationship between the first set of control signals 112A and the second set of control signals within a plurality of time periods. The plurality of time periods may include the first pre-specified time period and the second pre-specified time period. For example, if the first set of control signals 112A may be associated with an action of walking near a sofa at the first pre-specified time period, then the ML model 210 may calculate a probability of the user 108 sitting on the sofa within the second pre-specified time period (say within next 30 seconds from the current time). Similarly, the ML model 210 may calculate a probability of the user 108 to pick an item from the sofa within the second pre-specified time period. In one embodiment, the processor 202 may be configured to determine a set of second actions to be performed by the user 108 within the second pre-specified time period. The processor 202 may be further configured to calculate a probability for each of the set of second actions. The processor 202 may be further configured to compare the probability of each of the set of second actions with a predetermined threshold (say 0.8). The processor 202 may be configured to select the second action of the set of second actions based on the comparison (such as, if the calculated probability of the second action may be greater than the predetermined threshold). The processor 202 may be further configured to generate the second set of control signals to perform the second action within the second pre-specified time period (say within next 30 seconds from the current time).

In another example, to generate the second set of control signals, the ML model 210 may use the historical and real time data relating to the one or more customized maps 404. In an example, the historical and real time data of the retrieved one or more customized maps 404 may include a historical and real-time events relating to the traffic and congestion in the retrieved one or more customized maps 404, respectively. The ML model 210 may analyze the historical and real-time traffic and congestion data to generate the second set of control signals for a route plan of the user 108 in the retrieved one or more customized maps 404. The generated second set of control signals may ensure the reliable, accurate, and safe route plan for the user 108. In another example, the historical and real time data of the retrieved one or more customized maps 404 may include a historical and real-time events relating to the weather at the retrieved one or more customized maps 404. For example, the ML model 210 may analyze the historical and real-time events related to the weather within the second pre-specified time period to calculate any possible weather hazard occurrence in the retrieved one or more customized maps 404 within the second pre-specified time and generate the second set of control signals within the second pre-specified time period to avoid a route with calculated possible weather hazard occurrence. The second set of control signals may be associated with the second action.

At 502C, a second actuators controlling operation is performed. In the second actuators controlling operation 502C, the processor 202 may be configured to control the one or more actuators 310 embedded within the exoskeleton apparatus 102 based on the generated second set of control signals. The one or more actuators 310 may be controlled to assist the user 108 to perform the second action within the second pre-specified time period. In an example, the processor 202 may be further configured to control the second actuators of the one or more actuators 310 based on the second set of control signals. The second action may be performed within the second pre-specified time period (say next 30 seconds from the current time).

As an example, the processor 202 may be configured to determine the current location of the user 108 using the technologies such as the global positioning system (GPS) and/or indoor positioning system (IPS), and the like. The current location of the user 108 may be determined as the location ‘home’.

The processor 202 may be further configured to retrieve, from the map database, one or more customized maps 404 associated with the ‘home location’ of the user 108. The processor 202 may be further configured to receive the one or more brain signals 104A associated with the brain of the user 108. Based on the received one or more brain signals 104A, the processor 202 may be configured to determine the destination location of the user 108. The destination location may be determined as the ‘shopping mall’ location.

The processor 202 may be further configured to generate the first set of control signals 112A associated with the first action based on the retrieved one or more customized maps 404. In a generation of the first set of control signals 112A, the processor 202 may be configured to plan a first route for the user 108 to reach from the current location to the destination location. The processor 202 may be further configured to generate the first set of control signals 112A to assist the user 108 to walk on the first route. The first action may be performed using the first set of control signals 112A. The first set of control signals 112A may indicate the one or more navigation movements to assist the user 108 to walk and stay on the first route within the first pre-specified time period.

Further, the processor 202 may be configured to provide, as the input, the received one or more brain signals 104A, the retrieved one or more customized map 404, and the generated first set of control signals 112A to the ML model 210. The ML model 210 may be pre-trained on the historical dataset. Once the input may be provided to the ML model 210, the ML model 210 may analyze the historical and real-time events relating to the weather within the second pre-specified time period to calculate any possible weather hazard occurrence on the first route within the second pre-specified time period. The second pre-specified time period may be greater than the first pre-specified time period. For example, the first pre-specified time may indicate a time range of next 30 seconds from the current time and the second pre-specified time period may indicate a time range of next 30 seconds from an end of first pre-specified time period. The output of the ML model 210 may indicate, for example, an alternate route based on a possibility of a snow cover weather hazard occurrence on the first route within the second pre-specified time period. The snow cover may lead to an accident or fall on the first road due to less friction.

Further, the processor 202 may be configured to generate, based on the output of the ML model 210, the second set of control signals associated with the second action of the set of actions to be performed by the user 108 within the second pre-specified time period. Continuing with the present example, the processor 202 may be further configured to generate the second set of control signals to avoid the first route due to the calculated possibility of the snow cover weather hazard occurrence within the second pre-specified time period. In generation of the second set of control signals, the processor 202 may be configured to output the alternate second route for the user 108 to reach from the current location to the destination location and further generate the second set of control signals required to walk on the alternate second route. The second action associated with the second set of control signals may indicate one or more navigation movements required to walk and stay on the alternate second route within the second pre-specified time period. The generated second set of control signals may ensure the reliable, accurate, and safe route plan for the user 108.

FIG. 6 illustrates an exemplary scenario 600 that depicts an exemplary movement of user 108 wearing the exoskeleton apparatus 102 based on the brain signals, in accordance with an embodiment of the disclosure. FIG. 6 is explained in conjunction with elements from FIG. 1A, FIG. 1B, FIG. 2A, FIG. 2B, FIG. 3, FIG. 4, and FIG. 5. With reference to FIG. 6, there is shown the exemplary scenario 600 that illustrates an exemplary movement of user 108 within a “home” location from time ‘T1’ to time ‘T2’ wearing the exoskeleton apparatus 102.

At Time ‘T1’, the user 108 may wear the exoskeleton apparatus 102 to walk from one location to another location. The processor 202 may be configured to determine the current location of the user 108 using the technologies such as the global positioning system (GPS), and the like. The current location of the user 108 may be determined as the “home” location. The processor 202 may be further configured to retrieve, from the map database, one or more customized maps 404 that may be associated with the “home” location of the user 108. Specifically, the one or more customized maps 404 may be customized for the “home” location and may include information about one or more indoor locations (or rooms) in the home. In an embodiment, the one or more indoor locations may include, but not limited to, a bedroom, a sitting area, a hall, a master bedroom, and the like.

The processor 202 may be further configured to determine a current indoor location of the user 108. In an embodiment, the current indoor location of the user 108 may be one from the detected one or more indoor locations within the ‘home location’. The processor 202 may be further configured to receive the one or more brain signals 104A associated with the brain of the user 108. Based on the received one or more brain signals 104A, the processor 202 may be configured to determine an indoor destination location of the user 108 based on the application of the ML model 210 on the determined one or more brain signals 104A, and the retrieved one or more customized maps 404. The indoor destination location may be one of the detected one or more indoor locations of the user 108.

At time ‘T1’, the current indoor location of the user 108 may be determined as the ‘sitting area’ and the indoor destination location may be determined as the ‘master bedroom’ location for the user 108. The processor 202 may be further configured to generate the first set of control signals 112A associated with the first action based on the retrieved one or more customized maps 404 for movement of the user 108 from the ‘sitting area’ to the ‘master bedroom’. During the generation of the first set of control signals 112A, the processor 202 may be configured to determine a feasible route for the user 108 to reach from the current indoor location (e.g. ‘sitting area’) to the indoor destination location (e.g. ‘master bedroom’) without encountering any obstacles such as walls, or other objects. The processor 202 may be further configured to generate the first set of control signals 112A. The first set of control signals 112A may indicate the one or more navigation movements to assist the user 108 to walk on the feasible route within the first pre-specified time period. The first pre-specified time period may include a slice of time that starts from the time ‘T1’ and ends at the time ‘T2’.

The processor 202 may be further configured to control the one or more actuators 310 embedded within the exoskeleton apparatus 102 based on the generated first set of control signals 112A. The one or more actuators 310 may be controlled to assist the user 108 to perform the first action of walking on the feasible route within the first pre-specified time period. Once the first set of control signals 112A may be received by the two motors 306 of the exoskeleton apparatus 102, the two motors 306 may generate mechanical motion or force as instructed in the first set of control signals 112A. The mechanical motion may be performed to control the mobility of the exoskeleton apparatus 102 using the one or more actuators 310 to assist the user 108 to execute the first action in the first pre-specified time period.

At time ‘T2’, the execution of the first action in the first pre-specified time period may lead the exoskeleton apparatus 102 worn by the user 108 to reach the indoor destination location. As shown in FIG. 6, the user 108 may reach the ‘master bedroom’ location at time ‘T2’.

FIG. 7 illustrates an exemplary diagram for training and inference of the ML model 210, in accordance with an embodiment of the disclosure. FIG. 7 is explained in conjunction with elements from FIG. 1A, FIG. 1B, FIG. 2A, FIG. 2B, FIG. 3, FIG. 4, FIG. 5, and FIG. 6. As shown in FIG. 7, there is a training portion above line 700 and an inference portion below line 700.

The historical dataset 702 includes a set of training samples associated with at least one historical event. Each training sample of the set of training samples includes the one or more brain signals 702A and the frequency associated with the at least one historical event. The historical dataset 702 may also include the first action 702B performed by the user 108. The historical dataset 702 may further include the second action 702C being performed by the user 108 in the near future after the first action is performed by the user 108.

The historical dataset 702 may be aggregated at 706 to establish the determination of a future action 710 (or the second action 702C). The data acquisition 704 and the second action 702C, from aggregation 706, may be used as inputs to the ML model 210. The ML model 210 may further determine the future action 710 based on the data acquisition 704 and the second action 702C.

The ML model 210 may be trained using a large corpus of data and data types. For the first action 702B and for the second action 702C, the attributes of the first set of control signals associated with the first action 702B and/or the attributes of the second set of control signals associated with the second action 702C may be included in the data acquisition 704 and/or in the historical dataset 702. Examples of these first set of control signals attributes are shown in the FIG. 4 and FIG. 5 which depicts the first set of control signals attributes and their respective definitions. The first set of control signals attributes may include the information, for example, the angle, the speed, and the position information of the one or more actuators 310 within the first pre-specified time period. These attributes are not limiting, but examples of the first set of control signals attributes that may be used in the ML model 210 as described herein.

In one embodiment, the first set of control signals associated with the first action 702B may indicate joint movements such as the angle or position of each joint to enable walking, standing up, standing down, or other movements. The joints such as those at the hips, knees, and ankles. The first set of control signals may further indicate motor commands, the motor commands may instruct a motor to rotate clockwise to bend the knee joint using one or more actuators 310 embedded within the exoskeleton apparatus 102. The first action 702B may be used to train the ML model 210 and used as input elements associated with the second action 702C.

The ML model 210 may be trained at 708 using the one or more brain signals 702A, the first action 702B, and the second action 702C from the historical dataset 702. This training correlates the one or more brain signals 702A, the retrieved one or more customizable maps, the attributes of the first set of control signals, and the attributes of the second set of control signals. Using this information as the input, an inference may be made to predict the future action 710. Details about the prediction of the second action are provided, for example, in FIG. 5 and FIG. 6.

FIG. 8 is a first flowchart that illustrates an exemplary first method for assisting movement of user 108 using brain signals, in accordance with some embodiment of the disclosure. FIG. 8 is explained in conjunction with elements from FIG. 1A, FIG. 1B, FIG. 2A, FIG. 2B, FIG. 3, FIG. 4, FIG. 5, FIG. 6, and FIG. 7. With reference to FIG. 8, there is shown a flowchart 800. The operations of the exemplary method may be executed by any computing system, for example, by the exoskeleton apparatus 102 of FIG. 1A or the processor 202 of FIG. 2A. The operations of the flowchart 800 may start at 802.

At 802, the exoskeleton apparatus 102 may render the set of images 314 on the display device 110. In at least one embodiment, the processor 202 may be configured to render the set of images 314 on the display device 110. Each image of the set of images 314 may be associated with at least one action of the set of actions and fluctuates at the corresponding frequency. Details about the rendering of the set of images 314 using the display device 110 are provided, for example, in FIG. 4.

At 804, the one or more brain signals 104A associated with the brain of the user 108 may be received based on the rendered set of images 314. In at least one embodiment, the processor 202 may be configured to receive the one or more brain signals 104A associated with the brain of the user 108 based on the rendered set of images 314. Each of the received one or more brain signals 104A corresponds to the EEG signal associated with the brain of the user 108. Details about the reception of the one or more brain signals 104A are provided, for example, in FIG. 1A, FIG. 1B, and FIG. 4.

At 806, the first frequency associated with the received one or more brain signals 104A may be determined. In at least one embodiment, the processor 202 may be configured to determine the first frequency associated with the received one or more brain signals 104A. Details about the determination of the first frequency are provided, for example, in FIG. 4.

At 808, the determined first frequency may be compared with the frequency corresponding to each image of the set of images 314. In at least one embodiment, the processor 202 may be configured to compare the determined first frequency with the frequency corresponding to each image of the set of images 314. Details about the comparison of the determined first frequency with the corresponding frequency of each of the set of images 314 are provided, for example, in FIG. 4.

At 810, the first action to be performed by the user 108 within the first pre-specified time period may be determined based on the comparison. In at least one embodiment, the processor 202 may be configured to determine the first action to be performed by the user 108 within the first pre-specified time period based on the comparison. The first action may be included in the set of actions. Details about the determination of the first action based on the comparison are provided, for example, in FIG. 4.

At 812, the first set of control signals 112A associated with the determined first action may be generated. In at least one embodiment, the processor 202 may be configured to generate the first set of control signals 112A associated with the determined first action. Details about the generation of the first set of control signals 112A associated with the determined first action are provided, for example, in FIG. 4.

At 814, the one or more actuators 310 embedded within the exoskeleton apparatus 102 may be controlled based on the generated first set of control signals 112A. In at least one embodiment, the processor 202 may be configured to control the one or more actuators 310 embedded within the exoskeleton apparatus 102 based on the generated first set of control signals 112A. The one or more actuators 310 may be controlled to assist the user 108 to perform the first action within the first pre-specified time period. Details about the control of the exoskeleton apparatus 102 based on the first set of control signals 112A are provided, for example, in FIG. 4 and FIG. 6. Control may pass to end.

FIG. 9 is a second flowchart that illustrates an exemplary second method for assisting movement of user 108 using brain signals, in accordance with some embodiment of the disclosure. FIG. 9 is explained in conjunction with elements from FIG. 1A, FIG. 1B, FIG. 2A, FIG. 2B, FIG. 3, FIG. 4, FIG. 5, FIG. 6, FIG. 7 and FIG. 8. With reference to FIG. 9, there is shown a flowchart 900. The operations of the exemplary method may be executed by any computing system, for example, by the exoskeleton apparatus 102 of FIG. 1B or the processor 202 of FIG. 2A. The operations of the flowchart 900 may start at 902.

At 902, the one or more brain signals 104A associated with the brain of the user 108 may be received. In at least one embodiment, the processor 202 may be configured to receive the one or more brain signals 104A associated with the brain of the user 108. Each of the received one or more brain signals 104A corresponds to the EEG signal associated with the brain of the user 108. Details about the reception of the one or more brain signals 104A are provided, for example, in FIG. 1A, FIG. 1B, and FIG. 4.

At 904, the first set of control signals 112A associated with the first action to be performed by the user 108 within the first pre-specified time period may be generated. In at least one embodiment, the processor 202 may be configured generate the first set of control signals 112A associated with the first action to be performed by the user 108 within the first pre-specified time period based on the received one or more brain signals 104A. The first action may be included in the set of actions. Details about the generation of the first set of control signals 112A associated with the determined first action are provided, for example, in FIG. 4.

At 906, the received one or more brain signals 104A and the generated first set of control signals 112A may be provided as the input to the ML model 210. In at least one embodiment, the processor 202 may be configured to provide, as the input, the received one or more brain signals 104A and the generated first set of control signals 112A to the ML model 210. The ML model 210 may be pre-trained on the historical dataset 702. Details about the ML model 210 are provided, for example, in FIG. 2A, FIG. 5, and FIG. 7.

At 908, the second set of control signals associated with the second action to be performed by the user 108 within the second pre-specified time may be generated period based on the output of the ML model 210. In at least one embodiment, the processor 202 may be configured to generate, based on the output of the ML model 210, the second set of control signals associated with the second action to be performed by the user 108 within the second pre-specified time period. The second action may be included in the set of actions. Details about the generation of the second set of control signals associated with determined second action are provided, for example, in FIG. 5, and FIG. 7.

At 910, the one or more actuators 310 embedded within the exoskeleton apparatus 102 may be controlled based on the generated second set of control signals. In at least one embodiment, the processor 202 may be configured to control the one or more actuators 310 embedded within the exoskeleton apparatus 102 based on the generated second set of control signals. The one or more actuators 310 may be controlled to assist the user 108 to perform the second action within the second pre-specified time period. Details about the control of the one or more actuators 310 embedded within the exoskeleton apparatus 102 based on the generated second set of control signals are provided, for example, in FIG. 5. Control may pass to end.

Various embodiments of the disclosure may provide a non-transitory computer readable medium and/or storage medium having stored thereon, instructions executable by a machine and/or a computer to operate an exoskeleton apparatus (e.g., the exoskeleton apparatus 102) to assist movement of user using brain signals. The instructions may cause the machine and/or computer to perform operations that include render a set of images on a display device. Each image of the set of images may be associated with at least one action of a set of actions and fluctuates at a corresponding frequency. Further include receive one or more brain signals associated with a brain of a user based on the rendered set of images. Each of the received one or more brain signals corresponds to an electroencephalography (EEG) signal associated with the brain of the user. Further include determine a first frequency associated with the received one or more brain signals. Further include compare the determined first frequency with a frequency corresponding to each image of the set of images. Further include determine a first action to be performed by the user within a first pre-specified time period based on the comparison. The first action may be included in the set of actions. Further include generate a first set of control signals associated with the determined first action and control one or more actuators embedded within the exoskeleton apparatus based on the generated first set of control signals. The one or more actuators may be controlled to assist the user to perform the first action within the first pre-specified time period.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An exoskeleton apparatus, comprising:
a memory;
a processor communicatively coupled to the memory, wherein the processor is configured to:
render a set of images on a display device, wherein each image of the set of images is associated with at least one action of a set of actions and fluctuates at a corresponding frequency;
receive one or more brain signals associated with a brain of a user based on the rendered set of images, wherein each of the received one or more brain signals corresponds to an electroencephalography (EEG) signal associated with the brain of the user;
determine a first frequency associated with the received one or more brain signals;
compare the determined first frequency with a frequency corresponding to each image of the set of images;
determine a first action to be performed by the user within a first pre-specified time period based on the comparison, wherein the first action is included in the set of actions;
generate a first set of control signals associated with the determined first action; and
control one or more actuators embedded within the exoskeleton apparatus based on the generated first set of control signals, wherein the one or more actuators are controlled to assist the user to perform the first action within the first pre-specified time period.

2. The exoskeleton apparatus of claim 1, wherein the one or more brain signals are received from a wearable device, and wherein the wearable device comprises of one or more electrodes configured to capture the one or more brain signals.

3. The exoskeleton apparatus of claim 2, wherein the wearable device corresponds to at least one of: an invasive brain-controlled interface (BCI) wearable device, a partially invasive BCI wearable device, or a non-invasive BCI wearable device.

4. The exoskeleton apparatus of claim 2, wherein the wearable device corresponds to at least one of: an electroencephalography (EEG) headset, a functional near-infrared spectroscopy (fNIRS) device, an optical brain imaging device, a wearable electrode, a wearable cap, a wearable neurofeedback device, a neuromuscular sensing device, a neurostimulation wearable device, or an eyeglass.

5. The exoskeleton apparatus of claim 1, wherein the processor is configured to:
provide, as an input, the received one or more brain signals and the generated first set of control signals to a machine learning (ML) model, wherein the ML model is pre-trained on a historical dataset;
generate, based on an output of the ML model, a second set of control signals associated with a second action of the set of actions to be performed by the user within a second pre-specified time period, wherein the second pre-specified time period is greater than the first pre-specified time period; and
control the one or more actuators embedded within the exoskeleton apparatus based on the generated second set of control signals, wherein the one or more actuators are controlled to assist the user to perform the second action within the second pre-specified time period.

6. The exoskeleton apparatus of claim 5, wherein the processor is configured to:
retrieve the historical dataset including a set of training samples, wherein each training sample of the set of training samples comprises of the one or more brain signals, the first action, and the second action performed by the user; and
train the ML model using the retrieved historical dataset.

7. The exoskeleton apparatus of claim 1, wherein the processor is configured to:
determine a current location of the user;
retrieve, from a map database, one or more customized maps associated with the current location of the user based on the determined current location of the user; and
generate the first set of control signals associated with the determined first action based on the retrieved one or more customized maps.

8. The exoskeleton apparatus of claim 7, wherein each of the one or more customized maps are associated with at least one point of interest (Pol) associated with the user.

9. An exoskeleton apparatus, comprising:
a memory;
a processor communicatively coupled to the memory, wherein the processor is configured to:
receive one or more brain signals associated with a brain of a user, wherein each of the received one or more brain signals corresponds to an electroencephalography (EEG) signal associated with the brain of the user;
generate a first set of control signals associated with a first action to be performed by the user within a first pre-specified time period based on the received one or more brain signals, wherein the first action is included in a set of actions;
provide, as an input, the received one or more brain signals and the generated first set of control signals to a machine learning (ML) model, wherein the ML model is pre-trained on a historical dataset;
generate, based on an output of the ML model, a second set of control signals associated with a second action to be performed by the user within a second pre-specified time period, wherein the second action is included in the set of actions; and
control one or more actuators embedded within the exoskeleton apparatus based on the generated second set of control signals, wherein the one or more actuators are controlled to assist the user to perform the second action within the second pre-specified time period.

10. The exoskeleton apparatus of claim 9, wherein the one or more brain signals are received from a wearable device, and wherein the wearable device comprises of one or more electrodes configured to capture the one or more brain signals.

11. The exoskeleton apparatus of claim 10, wherein the wearable device corresponds to at least one of: an invasive brain-controlled interface (BCI) wearable device, a partially invasive BCI wearable device, or a non-invasive BCI wearable device.

12. The exoskeleton apparatus of claim 10, wherein the wearable device corresponds to at least one of: an electroencephalography (EEG) headset, a functional near-infrared spectroscopy (fNIRS) device, an optical brain imaging device, a wearable electrode, a wearable cap, a wearable neurofeedback device, a neuromuscular sensing device, a neurostimulation wearable device, or an eyeglass.

13. The exoskeleton apparatus of claim 9, wherein the processor is configured to:
retrieve the historical dataset including a set of training samples, wherein each training sample of the set of training samples comprises of the one or more brain signals, the first action, and the second action performed by the user; and
train the ML model using the retrieved historical dataset.

14. The exoskeleton apparatus of claim 9, wherein the processor is configured to:
render a set of images on a display device, wherein each image of the set of images is associated with at least one action of a set of actions and fluctuates at a corresponding frequency;
receive the one or more brain signals associated with the brain of the user based on the rendered set of images;
determine a first frequency associated with the received one or more brain signals;
compare the determined first frequency with a frequency corresponding to each image of the set of images;
determine the first action to be performed by the user within a first pre-specified time period based on the comparison, wherein the first action is included in the set of actions; and
generate the first set of control signals associated with the determined first action of the set of actions to be performed by the user.

15. The exoskeleton apparatus of claim 9, wherein the processor is configured to:
determine a current location of the user;
retrieve, from a map database, one or more customized maps associated with the current location of the user based on the determined current location of the user; and
generate, based on the retrieved one or more customized maps, at least one of the first set of control signals or the second set of control signals.

16. The exoskeleton apparatus of claim 15, wherein the each of the one or more customized maps is associated with at least one point of interest (Pol) associated with the user.

17. A method implemented in an exoskeleton apparatus, the method comprising:
rendering a set of images on a display device, wherein each image of the set of images is associated with at least one action of a set of actions and fluctuates at a corresponding frequency;
receiving one or more brain signals associated with a brain of a user based on the rendered set of images, wherein each of the received one or more brain signals corresponds to an electroencephalography (EEG) signal associated with the brain of the user;
determining a first frequency associated with the received one or more brain signals;
comparing the determined first frequency with a frequency corresponding to each image of the set of images;
determining a first action to be performed by the user within a first pre-specified time period based on the comparison, wherein the first action is included in the set of actions;
generating a first set of control signals associated with the determined first action; and
controlling one or more actuators embedded within the exoskeleton apparatus based on the generated first set of control signals, wherein the one or more actuators are controlled to assist the user to perform the first action within the first pre-specified time period.

18. The method of claim 17, wherein the one or more brain signals are received from a wearable device, and wherein the wearable device comprises of one or more electrodes configured to capture the one or more brain signals.

19. The method of claim 17, further comprising:
providing, as an input, the received one or more brain signals and the generated first set of control signals to a machine learning (ML) model, wherein the ML model is pre-trained on a historical dataset;
generating, based on an output of the ML model, a second set of control signals associated with a second action of the set of actions to be performed by the user within a second pre-specified time period, wherein the second pre-specified time period is greater than the first pre-specified time period; and
controlling the one or more actuators embedded within the exoskeleton apparatus based on the generated second set of control signals, wherein the one or more actuators are controlled to assist the user in performing the second action within the second pre-specified time period.

20. The method of claim 19, further comprising:
retrieving the historical dataset including a set of training samples, wherein each training sample of the set of training samples comprises of the one or more brain signals, the first action, and the second action performed by the user; and
training the ML model using the retrieved historical dataset.
